(19) United States
(12) Patent Application Publication
(10) Pub. No.: US 2025/0379859 A1
(43) Pub. Date: Dec. 11, 2025

(54) On-Grid and Off-Grid Secure Messaging

(71) Applicant: Apple Inc., Cupertino, CA (US)

(72) Inventors: Frederic Jacobs, St. Sulpice (CH); Alexander Balducci, Cupertino, CA (US); Ninglin Zhang, Cupertino, CA (US); Nelson M. LeDuc, Cupertino, CA (US); Steven A. Myers, Cupertino, CA (US)

(73) Assignee: Apple Inc., Cupertino, CA (US)

(21) Appl. No.: 19/094,593

(22) Filed: Mar. 28, 2025

Related U.S. Application Data
(60) Provisional application No. 63/657,922, filed on Jun. 9, 2024.

(51) Int. Cl. H04L 9/40

(52) U.S. Cl. CPC H04L 63/0435

(57) ABSTRACT

On-grid and off-grid secure messaging is described. In one or more implementations, a first electronic device communicates a sender key over a first network to a second electronic device. The sender key enables encryption and decryption of messages communicated between the first electronic device and the second electronic device when the first network is inaccessible by the first electronic device. Responsive to input, at the first electronic device, to communicate a message to the second electronic device when the first network is inaccessible by the first electronic device, the first electronic device encrypts the message using a message key generated based on the sender key and communicates the message encrypted with the message key over a second network to the second electronic device.

### RELATED APPLICATION

This application claims priority to U.S. Provisional Patent Application No. 63/657,922 filed, Jun. 9, 2024, the disclosure of which is hereby incorporated by reference in its entirety.

### BACKGROUND

When electronic devices communicate off-grid via satellite to electronic devices that are on-grid, various concerns arise. For instance, a satellite communication link itself can be vulnerable to interception and eavesdropping. Since satellite signals can be intercepted with the right equipment, sensitive data transmitted through such a link may be at risk of being captured by malicious attackers. Additionally, satellite communication infrastructures may not have the same level of encryption and security protocols as terrestrial networks, increasing the risk of data breaches. Unauthorized access to satellite communication systems could also lead to tampering with data being transmitted or even disrupting the communication channel.

The integration between off-grid satellite communications and on-grid cellular networks also introduces potential vulnerabilities. In some scenarios, data transmitted from satellite networks transitions through various gateways and potentially untrusted networks before reaching an on-grid, recipient electronic device. Each transition point presents an opportunity for cyberattacks, such as man-in-the-middle attacks, where attackers can intercept and alter data. Furthermore, differences in security protocols and standards between satellite networks and terrestrial cellular networks can create gaps for attackers to exploit. Ensuring end-to-end encryption and robust authentication mechanisms is crucial to mitigate these risks, but implementing and maintaining such security measures across different types of networks can be complex and challenging.

### BRIEF DESCRIPTION OF THE DRAWINGS

FIG. 1 is a block diagram illustrating a device.

FIGS. 2A-2F depict example implementations for on-grid and off-grid secure messaging.

FIG. 3 depicts a non-limiting example of on-grid and off-grid secure messaging, in accordance with one or more implementations.

FIG. 4 depicts a non-limiting example in which sender keys are exchanged between devices on-grid to enable secure communication when subsequently off-grid by encrypting messages using lighter weight message keys based on the sender keys.

FIG. 5 depicts a procedure for on-grid and off-grid secure messaging.

### DETAILED DESCRIPTION

On-grid and off-grid secure messaging is described. The described systems, devices, and techniques provide secure communication between electronic devices, particularly when transitioning between different types of networks, such as on-grid cellular networks and off-grid satellite networks. As described herein, devices can communicate over a first network and a second network. The first network has one or more characteristics which are different from the second network, which enable the devices to communicate (e.g., exchange messages) better over the first network than over the second network. For instance, the first network has higher bandwidth and/or lower latency than the second network and the second network has lower bandwidth (e.g., constrained bandwidth) and/or higher latency than the first network. In at least one implementation, this is because the first network and the second network are different types of communication networks. By way of example, in at least one implementation, the first network is a non-terrestrial network (e.g., a wireless broadband network that includes one or more of cellular and/or Wi-Fi networking devices) and the second network is a terrestrial network (e.g., a satellite network or constellation comprising at least one satellite).

While devices are connected to a first network, communication (e.g., the exchange of messages and/or phone calls) may be referred to as “on-grid,” referring to the relative ubiquity and thus ability of those devices to easily connect at any given time to the network within locations covered by networking hardware of the first network. In contrast, a device that relies on a second network to communicate may be referred to as being “off-grid,” because the ubiquitous, higher-bandwidth capabilities (e.g., available over the first network) are inaccessible to the device, limiting the ability of the device to communicate various payloads and/or limiting the ability of the device to communicate as quickly as over the first network.

In accordance with the described techniques, a first electronic device and a second electronic device communicate on-grid over the first network, including by exchanging one or more messages (e.g., instant messages) between each other. For instance, the first electronic device sends messages (e.g., instant messages) to and receives messages from the second electronic device. Similarly, the second electronic device sends messages to and receives messages from the first electronic device. The first electronic device and the second electronic device may also communicate in other ways over the first network, such as by voice calls, text (SMS) messages, e-mail, and/or other forms of electronic communication.

While communicating (e.g., messaging) with each other on-grid over the first network, the first electronic device and the second electronic device exchange keys to use subsequently for secure off-grid communication, e.g., when at least one of the first electronic device or the second electronic device is off-grid communicating with the other device via the second network. For example, the first electronic device generates a sender key and communicates the sender key to the second electronic device. Both devices store the sender key in respective local storage. The sender key enables encryption and decryption of messages communicated between the first electronic device and the second electronic device when the first network is inaccessible to the first electronic device, e.g., when the first electronic device is communicating from an off-grid location.

In particular, the sender key is used by the first electronic device to generate a message key that is unique to the message. The message key is a lighter weight key (a “lightweight” key) relative to the sender key and is usable when bandwidth is constrained, such as in connection with messaging over the second network. In one or more implementations, at least one aspect of the sender keys and/or their exchange is unsuitable for performing the exchange over the second network. For instance, sender keys may be too large to reliably send them over the second network. When off-grid, the first electronic device encrypts the message with the message key and communicates the encrypted message to the second electronic device over the second network. The second electronic device receives the message encrypted with the message key and decrypts the message using the sender key previously stored locally by the second electronic device.

In one or more implementations, the first electronic device generates and communicates sender keys selectively to other electronic devices, e.g., to the second electronic device. For instance, the first electronic device exchanges sender keys with other electronic devices that are associated with contacts of a user of the first electronic device which satisfy one or more conditions. In at least one implementation, sender keys are exchanged only with high-priority contacts of a user of the first electronic device. By way of example, a user associated with the second electronic device may be identified as a high-priority contact of the user of the first electronic device due to being identified as at least of the following in relation to the user of the first electronic device: a family contact, a pinned contact (e.g., that is “pinned” to a prominent region of a messaging user interface of a messaging application), an emergency contact, and/or a contact included in a particular list of contacts such as an “approved list” or list of friends, to name just a few. Alternatively or additionally, the first electronic device communicates the sender key to devices based on frequent or recent communication of messages between the devices. In one or more implementations, “frequent” communication refers to the communication of messages between devices satisfying a threshold frequency, and “recent” communication refers to the communication of messages between devices satisfying a threshold recency, e.g., within a threshold period of time from a current time.

In one or more implementations, the sender key is communicated by the first electronic device over the first network to the second electronic device in connection with an exchange of messages between the first electronic device and the second electronic device. By way of example, the first electronic device communicates the sender key in the background in connection with a messaging session between the first electronic device and the second electronic device, such as over a separate channel established over the first network in connection with the messaging session. The sender keys exchanged between devices are unique to the exchange of messages between the devices. For example, the sender key is not used and is not useable between the first electronic device and any electronic device that is different from the second electronic device. In this way, a third electronic device is not provided information (e.g., the sender key) used to secure communication (e.g., messaging) which are intended to be private between the first electronic device and the second electronic device. This ensures that the sender keys exchanged between two electronic devices are usable only by those two electronic devices to encrypt and decrypt messages exchanged between those two electronic devices.

By way of example, sender keys exchanged between the first electronic device and the second electronic device are unique to an exchange of messages between those two electronic devices. In at least one implementation, this is because the sender keys are based on at least one characteristic of the exchange of messages between those two devices, such as a number of messages exchanged (e.g., since a sender key was last communicated between the devices), the content of one or more exchanged messages (e.g., the actual text, emojis, other content such as images or videos, expressions of sentiment such as likes and dislikes, etc.), one or more timestamps, a location of one or more of the electronic devices when a message is sent or received, and so on. In at least one implementation, the first electronic device uses the characteristic of the exchange of messages with the second electronic device as input (e.g., key derivation material) to generate the sender key.

After the first electronic device generates the sender key, the first electronic device communicates the generated sender key to the second electronic device. As noted above, the first electronic device and the second electronic device are each configured to store the sender key. In one or more implementations, the first electronic device and the second electronic device store the sender key in association with an exchange of messages between those devices. For instance, each of the first electronic device and the second electronic device tracks (e.g., stores) the sender keys received from other devices as well as a particular message exchange (e.g., conversation) during which an individual sender key is received. When off-grid, therefore, a device can retrieve its own sender keys for a respective message exchange from storage.

In accordance with the described techniques, the first electronic device receives input to send a message to the second electronic device when the first network is inaccessible to the first electronic device, such as when the first electronic device is off grid. When the first electronic device is off grid, for example, a user of the first electronic device interacts with a messaging user interface provided by the first electronic device to compose and then select to send the message to the second electronic device. Responsive to such input, the first electronic device encrypts the message using the message key and sends the message encrypted using the message key to the second electronic device via the second network.

In one or more implementations, the first electronic device generates the message key by retrieving the sender key from storage of the first electronic device. After the sender key is retrieved from storage of the first electronic device, the first electronic device derives the message key based on the sender key and optionally based on at least one characteristic of an exchange of messages between the first electronic device and the second electronic device. In one or more implementations, the characteristic is particular to the exchange of messages between the first electronic device and the second electronic device since a sender key was last communicated between the first electronic device and the second electronic device. In this way, when a new sender key is sent, the characteristic used is determined based on a new set of messages, e.g., the messages exchanged since the new sender key was sent.

Through the described on-grid exchange of sender keys which are usable by devices while subsequently off-grid to generate lightweight message keys for cryptographically securing and then communicating messages off-grid, the techniques described herein provide a variety of improvements. For instance, the described techniques provide improved security during off-grid communications, as the sender keys enable robust encryption that is less susceptible to interception and eavesdropping. Additionally, the techniques allow for a seamless transition between networks (e.g., wireless broadband to satellite) without compromising the integrity of the data being transmitted. The selective communication of sender keys based on factors such as frequency of communication, priority contacts, and message exchanges further strengthens the security by minimizing the exposure of encryption keys. Moreover, the ability to store sender keys for predefined time periods and associate them with specific message exchanges simplifies the management of encryption keys while maintaining a high level of security. The generation of message keys based on sender keys and characteristics of message exchanges provides an additional layer of security, as it creates a dynamic encryption environment that is difficult for attackers to penetrate.

The described techniques also provide forward secrecy for message exchanges involving at least one off-grid electronic device. The term “forward secrecy,” as used herein, refers to preventing an attacker from being able to decrypt past message traffic due to a compromise of a future message communication. This is achieved by updating key derivation material (e.g., ratcheting the sender key) as well as by distributing the sender keys on a per-message basis, providing per-message forward secrecy. The described techniques also provide post-compromise security for message exchanges involving at least one off-grid electronic device. The term “post-compromise security,” as used herein, refers to the ability of the system to recover from a compromised state, such that an attacker is prevented from decrypting future traffic between electronic devices after a compromise occurs. The described techniques recover from a compromised state by rolling the sender keys, such that sending a new sender key over a secure channel can result in recovery from a compromised state. Additionally, ratcheting may be utilized in order to generate new key derivation material to derive a next message key for encrypting messages on a per message basis. Due to this, forward secrecy is recovered in most cases when a message recipient comes back online. In addition to these benefits, the described techniques may also provide security against some attacks from quantum computers (e.g., passive quantum attackers) due to the use of 256-bit symmetric cryptography (e.g., SHA-256) when generating sender key identifiers.

In summary, the described systems, devices, and techniques provide a secure, flexible, and efficient approach to maintaining data integrity and confidentiality across diverse communication networks, thereby addressing the challenges associated with integrating on-grid and off-grid communication systems.

### Electronic Device

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable communications devices include, without limitation, the iPhone®, iPod Touch®, iPad®, Apple Watch, and Vision Pro devices from Apple Inc. of Cupertino, Calif. Other portable communications devices, such as wearable device, laptops or tablet computers with messaging functionality, are, optionally, used. It should also be understood that, in some embodiments, the device is not a portable communications device, but is a desktop computer with messaging functionality. In some embodiments, the device is one or more of a TV, set top box, media player, speaker, security system, camera, thermostat, light switch, door lock, appliance, IoT device, vehicle, robot, vacuum, and the like. In some embodiments, the device is a wearable device (e.g., watch, headphone, etc. with messaging functionality.

In the discussion that follows, an electronic device is described. It should be understood that the electronic device optionally includes a display and a touch sensitive surface. Alternatively or additionally, the electronic device optionally includes one or more other physical user-interface devices, such as a physical keyboard, a mouse, and/or a joystick.

In addition to messaging functionality, such as in connection with a messaging application, the device may also support a variety of other applications, such as one or more of the following: a note taking application, a drawing application, a presentation application, a word processing application, a spreadsheet application, a gaming application, a telephone application, a video conferencing application, an e-mail application, a workout support application, a photo management application, a digital camera application, a digital video camera application, a web browsing application, a digital music player application, a digital wallet application, and/or a digital video player application.

The various applications that are executed on the device optionally use at least one common physical user interface device, such as a touch-sensitive surface of the device. One or more functions of the touch-sensitive surface as well as corresponding information displayed on the device are, optionally, adjusted and/or varied from one application to the next and/or within a respective application. In this way, a common physical architecture of the device optionally supports the variety of applications with user interfaces that are intuitive and transparent to the user.

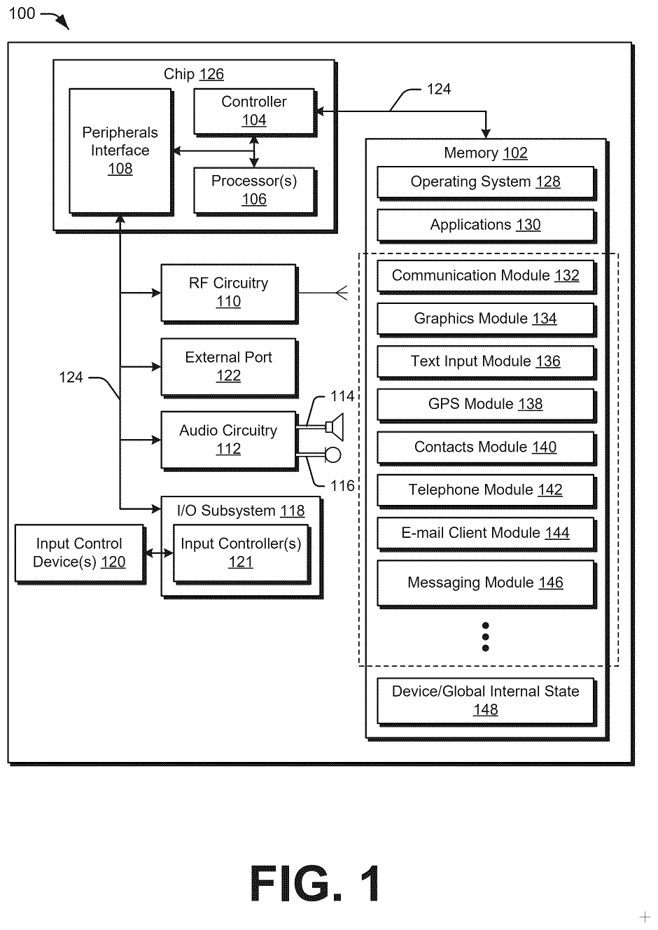

Attention is now directed toward embodiments of portable devices that support on-grid and off-grid messaging functionality. FIG. 1 is a block diagram illustrating a device 100. Device 100 includes memory 102 (which optionally includes one or more computer readable storage mediums), memory controller 104, one or more processors 106 (e.g., CPUs, GPUs, DSPs, etc.) which may optionally be referred to herein as one or more processing units, peripherals interface 108, RF circuitry 110, audio circuitry 112, speaker 114, microphone 116, input/output (I/O) subsystem 118, other input or control devices 120, and external port 122. These components optionally communicate over one or more communication buses or signal lines 124.

It should be appreciated that device 100 is only one example of a an electronic device, and that device 100 optionally has more or fewer components than shown, optionally combines two or more components, or optionally has a different configuration or arrangement of the components. The various components shown in FIG. 1 are implemented in hardware, software, firmware, or a combination thereof, including one or more signal processing and/or application specific integrated circuits.

Memory 102 optionally includes high-speed random access memory and optionally also includes nonvolatile memory, such as one or more magnetic disk storage devices, flash memory devices, or other non-volatile solid state memory devices. Access to memory 102 by other components of device 100, such as the one or more processors 106 and the peripherals interface 108, is, optionally, controlled by the memory controller 104.

Peripherals interface 108 can be used to couple input and output peripherals of the device to the one or more processors 106 and memory 102. The one or more processors 106 run or execute various software programs and/or sets of instructions stored in memory 102 to perform various functions for device 100 and to process data.

In some embodiments, the peripherals interface 108, the one or more processors 106, and the memory controller 104 are, optionally, implemented on a single chip, such as chip 126. In some other embodiments, they are, optionally, implemented on separate chips.

RF (radio frequency) circuitry 110 receives and sends RF signals, also called electromagnetic signals. The RF circuitry 110 converts electrical signals to/from electromagnetic signals and communicates with communications networks and other communications devices via the electromagnetic signals. The RF circuitry 110 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 110 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 110 also optionally communicates with networks, such as terrestrial networks (e.g., satellite networks), examples of which include but are not limited to a network (constellation) of satellites operated by Globalstar, Inc., and the Iridium satellite constellation operated by Iridium Communications Inc., by wireless communication. The various wireless communications optionally use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 112, speaker 114, and microphone 116 provide an audio interface between a user and device 100. Audio circuitry 112 receives audio data from peripherals interface 108, converts the audio data to an electrical signal, and transmits the electrical signal to speaker 114. Speaker 114 converts the electrical signal to human-audible sound waves. Audio circuitry 112 also receives electrical signals converted by microphone 116 from sound waves. Audio circuitry 112 converts the electrical signal to audio data and transmits the audio data to peripherals interface 108 for processing. Audio data is, optionally, retrieved from and/or transmitted to memory 102 and/or RF circuitry 110 by peripherals interface 108.

I/O subsystem 118 couples input/output peripherals on device 100, such as input or control devices 120, with peripherals interface 108. I/O subsystem 118 one or more input controllers 121 for any of a variety of input or control devices 120.

Device 100 optionally includes various devices and/or systems for obtaining information concerning the location and orientation (e.g., portrait or landscape) of device 100, examples of which include but are not limited to accelerometer(s) (not shown) a magnetometer (not shown), and a GPS (or GLONASS or other global navigation system) receiver (not shown).

In some embodiments, the software components stored in memory 102 include operating system 128, applications 130, communication module (or set of instructions) 132, graphics module (or set of instructions) 134, text input module (or set of instructions) 136, Global Positioning System (GPS) module (or set of instructions) 138, contacts module (or set of instructions) 140, telephone module (or set of instructions) 142, e-mail client module (or set of instructions) 144, and instant messaging module (or set of instructions) 146. Furthermore, in some embodiments, memory 102 stores device/global internal state 148, as shown in FIG. 1. Device/global internal state 148 includes one or more of: active application state, indicating which applications, if any, are currently active; off-grid messaging state, indicating a status of encrypted messages sent over a terrestrial network to another device using the RF circuitry 110 and/or other information regarding such communications and the cryptographic securing of those communications; sensor state, including information obtained from the device's various sensors and other input or control devices 120; and location and/or positional information concerning the device's location and/or attitude.

Operating system 128 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 132 facilitates communication with other devices over one or more external ports 122 and also includes various software components for handling data received by RF circuitry 110 and/or external port 122.

In conjunction with RF circuitry 110, various systems of the device 100 (e.g., a touch-sensitive display system, display controller, and device contact module (not shown) along with graphics module 134, text input module 136, contacts module 140, e-mail client module 144, and messaging module 146 (e.g., an instant messaging module) include executable instructions to enter a sequence of characters corresponding to a message (e.g., an instant message), to modify previously entered characters, to transmit a respective message (for example, using a Short Message Service (SMS) or Multimedia Message Service (MMS) protocol for telephony-based messages or using XMPP, SIMPLE, Apple Push Notification Service (APNs) or IMPS for Internet-based instant messages), to receive messages, to view received messages, and to perform messaging functionality (e.g., of a messaging application). In some embodiments, transmitted and/or received messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

Each of the above identified modules and applications corresponds to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, the memory 102 optionally stores additional modules and data structures not described above.

### Application Programming Interfaces (APIs)

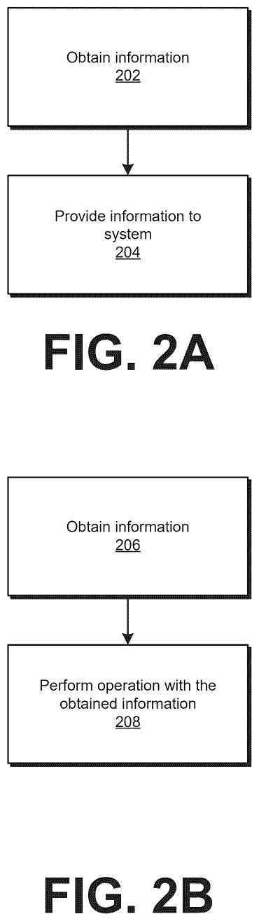

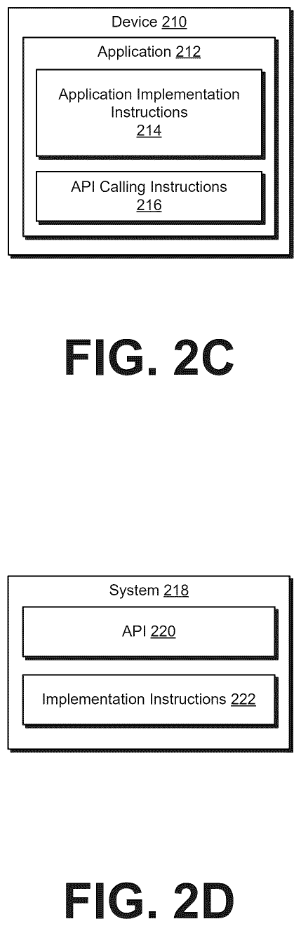

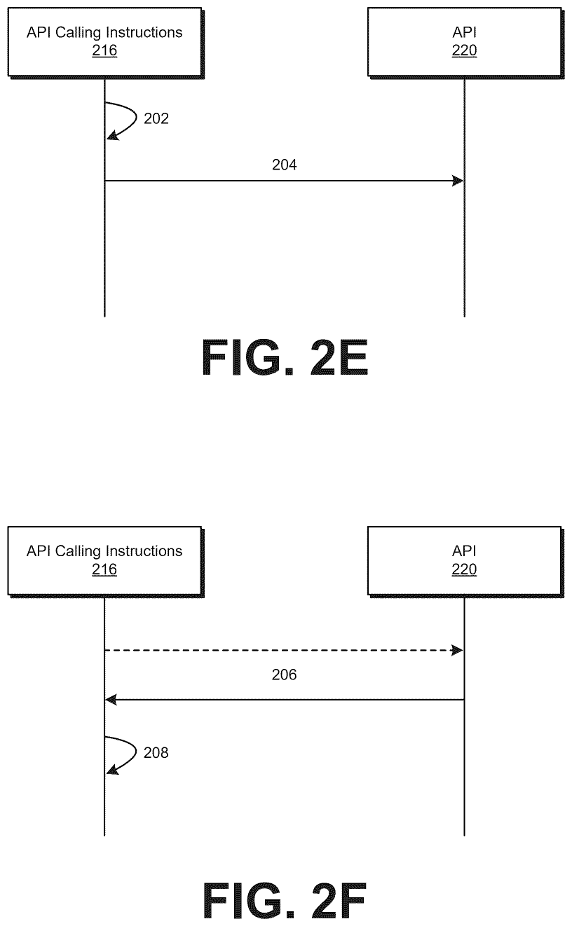

FIGS. 2A-2F depict example implementations for on-grid and off-grid secure messaging.

Implementations within the scope of the present disclosure can be partially or entirely realized using a tangible computer-readable storage medium (or multiple tangible computer-readable storage media of one or more types) encoding one or more computer-readable instructions. In one or more implementations, the tangible computer-readable storage media is non-transitory computer-readable storage media. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 212) that, when executed by one or more processing units, control an electronic device (e.g., device 210) to perform the method of FIG. 2A, the method of FIG. 2B, and/or one or more other processes and/or methods described herein.

It should be recognized that application 212 (shown in FIG. 2C) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 212 is an application that is pre-installed on device 210 at purchase (e.g., a first party application). In other embodiments, application 212 is an application that is provided to device 210 via an operating system update file (e.g., a first party application or a second party application). In other embodiments, application 212 is an application that is provided via an application store. In some embodiments, the application store can be an application store that is pre-installed on device 210 at purchase (e.g., a first party application store). In other embodiments, the application store is a third-party application store (e.g., an application store that is provided by another application store, downloaded via a network, and/or read from a storage device).

Referring to FIG. 2A and FIG. 2E, application 212 obtains information (e.g., 202). In some embodiments, at 202, information is obtained from at least one hardware component of the device 210. In some embodiments, at 202, information is obtained from at least one software module (e.g., set of instructions) of the device 210. In some embodiments, at 202, information is obtained from at least one hardware component external to the device 210 (e.g., a peripheral device, an accessory device, a server, etc.). In some embodiments, the information obtained at 202 includes positional information, time information, notification information, user information, environment information, electronic device state information, weather information, media information, historical information, event information, hardware information, and/or motion information. In some embodiments, in response to and/or after obtaining the information at 202, application 212 provides the information to a system (e.g., 204).

In some embodiments, the system (e.g., 218 shown in FIG. 2D) is an operating system hosted on the device 210. In some embodiments, the system (e.g., 218 shown in FIG. 2D) is an external device (e.g., a server, a peripheral device, an accessory, a personal computing device, etc.) that includes an operating system.

Referring to FIG. 2B and FIG. 2F, application 212 obtains information (e.g., 206). In some embodiments, the information obtained at 206 includes positional information, time information, notification information, user information, environment information electronic device state information, weather information, media information, historical information, event information, hardware information and/or motion information. In response to and/or after obtaining the information at 206, application 212 performs an operation with the information (e.g., 208). In some embodiments, the operation performed at 208 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 218 based on the information.

In some embodiments, one or more steps of the method of FIG. 2A and/or the method of FIG. 2B is performed in response to a trigger. In some embodiments, the trigger includes detection of an event, a notification received from system 218, a user input, and/or a response to a call to an API provided by system 218.

In some embodiments, the instructions of application 212, when executed, control the device 210 to perform the method of FIG. 2A and/or the method of FIG. 2B by calling an application programming interface (API) (e.g., API 220) provided by system 218. In some embodiments, application 212 performs at least a portion of the method of FIG. 2A and/or the method of FIG. 2B without calling API 220.

In some embodiments, one or more steps of the method of FIG. 2A and/or the method of FIG. 2B includes calling an API (e.g., API 220) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 2C, device 210 is illustrated. In some embodiments, device 210 is a personal computing device, a smart phone, a smart watch, a fitness tracker, a head mounted display (HMD) device, a media device, a communal device, a speaker, a television, smart home device, security system, camera, thermostat, light switch, door lock, appliance, IoT device, vehicle, robot, vacuum, and/or a tablet. Device 210 includes application 212 and an operating system (not shown) (e.g., system 218 shown in FIG. 2D). Application 212 includes application implementation instructions 214 and API calling instructions 216. System 218 includes API 220 and implementation instructions 222. It should be recognized that device 210, application 212, and/or system 218 can include more, fewer, and/or different components than illustrated in FIGS. 2C and 2D.

In some embodiments, application implementation instructions 214 is a software module that includes a set of one or more computer-executable instructions. In some embodiments, the set of one or more instructions of the application implementation instructions 214 corresponds to one or more operations performed by application 212. For example, when application 212 is a messaging application, application implementation instructions 214 can include operations to receive and send messages. In some embodiments, application implementation instructions 214 communicates with API calling instructions to communicate with system 218 via API 220 (shown in FIG. 2D).

In some embodiments, API calling instructions 216 is a software module that includes a set of one or more computer-executable instructions.

In some embodiments, implementation instructions 222 is a software module that includes a set of one or more computer-executable instructions.

In some embodiments, API 220 is a software module that includes a set of one or more computer-executable instructions. In some embodiments, API 220 provides an interface that allows a different set of instructions (e.g., API calling instructions 216) to access and/or use one or more functions, methods, procedures, data structures, classes, and/or other services provided by implementation instructions 222 of system 218. For example, API calling instructions 216 can access a feature of implementation instructions 222 through one or more API calls or invocations (e.g., embodied by a function or a method call) exposed by API 220 and can pass data and/or control information using one or more parameters via the API calls or invocations. In some embodiments, API 220 allows application 212 to use a service provided by a Software Development Kit (SDK) library. In other embodiments, application 212 incorporates a call to a function or method provided by the SDK library and provided by API 220 or uses data types or objects defined in the SDK library and provided by API 220. In some embodiments, API calling instructions 216 makes an API call via API 220 to access and use a feature of implementation instructions 222 that is specified by API 220. In such embodiments, implementation instructions 222 can return a value via API 220 to API calling instructions 216 in response to the API call. The value can report to application 212 the capabilities or state of a hardware component of device 210, including those related to aspects such as input capabilities and state, output capabilities and state, processing capability, power state, storage capacity and state, and/or communications capability. In some embodiments, API 220 is implemented in part by firmware, microcode, or other low-level logic that executes in part on the hardware component.

In some embodiments, API 220 allows a developer of API calling instructions 216 (which can be a third-party developer) to leverage a feature provided by implementation instructions 222. In such embodiments, there can be one or more set of API calling instructions (e.g., including API calling instructions 216) that communicate with implementation instructions 222. In some embodiments, API 220 allows multiple sets of API calling instructions written in different programming languages to communicate with implementation instructions 222 (e.g., API 220 can include features for translating calls and returns between implementation instructions 222 and API calling instructions 216) while API 220 is implemented in terms of a specific programming language. In some embodiments, API calling instructions 216 calls APIs from different providers such as a set of APIs from an OS provider, another set of APIs from a plug-in provider, and/or another set of APIs from another provider (e.g., the provider of a software library) or creator of the other set of APIs.

Examples of API 220 can include one or more of: off-grid secure messaging API, a pairing API (e.g., for establishing secure connection, e.g., with an accessory), a device detection API (e.g., for locating nearby devices, e.g., media devices and/or smartphone), a location detection API, a locator API, a maps API, a sensor API, a messaging API, a push notification API, a streaming API, a web browser API (e.g., WebKit API), a networking API, a Wi-Fi API, a Bluetooth API, an NFC API, a UWB API, contact transfer API, photos API, camera API, and/or image processing API. In some embodiments the sensor API is an API for accessing data associated with a sensor of device the 210. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 222 is a system (e.g., operating system, server system) software module (e.g., a collection of computer-readable instructions) that is constructed to perform an operation in response to receiving an API call via API 220. In some embodiments, implementation instructions 222 is constructed to provide an API response (via API 220) as a result of processing an API call. By way of example, implementation instructions 222 and API calling instructions 216 can each be any one of an operating system, a library, a device driver, an API, an application program, or other module. It should be understood that implementation instructions 222 and API calling instructions 216 can be the same or different type of software module from each other. In some embodiments, implementation instructions 222 is embodied at least in part in firmware, microcode, or other hardware logic.

In some embodiments, implementation instructions 222 returns a value through API 220 in response to an API call from API calling instructions 216. While API 220 defines the syntax and result of an API call (e.g., how to invoke the API call and what the API call does), API 220 might not reveal how implementation instructions 222 accomplishes the function specified by the API call. Various API calls are transferred via the one or more application programming interfaces between API calling instructions 216 and implementation instructions 222. Transferring the API calls can include issuing, initiating, invoking, calling, receiving, returning, and/or responding to the function calls or messages. In other words, transferring can describe actions by either of API calling instructions 216 or implementation instructions 222. In some embodiments, a function call or other invocation of API 220 sends and/or receives one or more parameters through a parameter list or other structure.

In some embodiments, implementation instructions 222 provides more than one API, each providing a different view of or with different aspects of functionality implemented by implementation instructions 222. For example, one API of implementation instructions 222 can provide a first set of functions and can be exposed to third party developers, and another API of implementation instructions 222 can be hidden (e.g., not exposed) and provide a subset of the first set of functions and also provide another set of functions, such as testing or debugging functions which are not in the first set of functions. In some embodiments, implementation instructions 222 calls one or more other components via an underlying API and thus be both a set of API calling instructions and a set of implementation instructions. It should be recognized that implementation instructions 222 can include additional functions, methods, classes, data structures, and/or other features that are not specified through API 220 and are not available to API calling instructions 216. It should also be recognized that API calling instructions 216 can be on the same system as implementation instructions 222 or can be located remotely and access the implementation instructions 222 using API 220 over a network. In some embodiments, implementation instructions 222, API 220, and/or API calling instructions 216 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

### Secure Messaging Protocol and Associated Processes

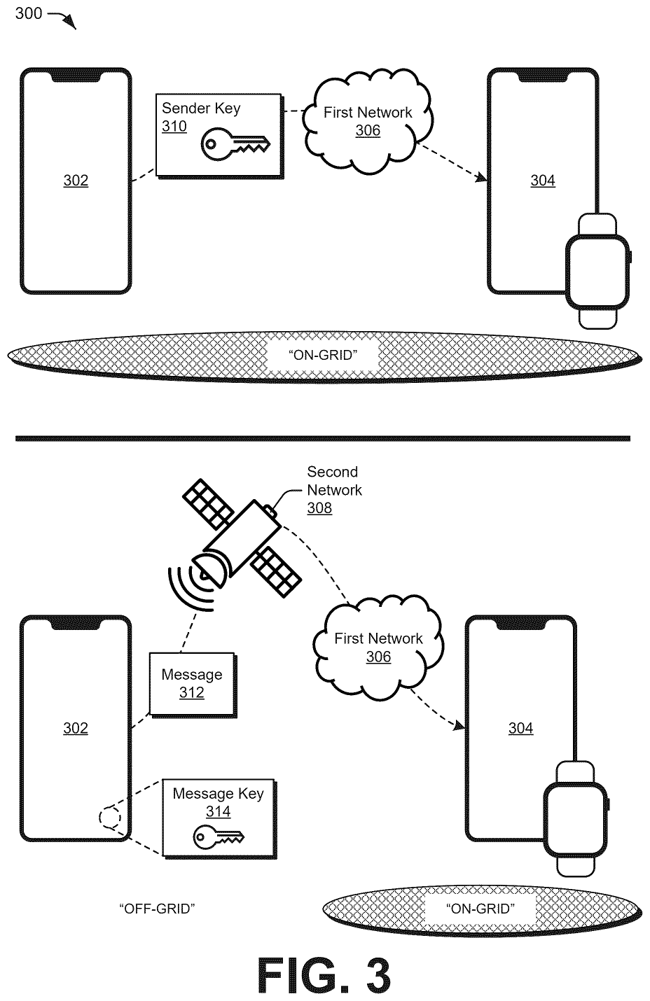

FIG. 3 depicts a non-limiting example 300 of on-grid and off-grid secure messaging, in accordance with one or more implementations.

This example 300 includes a first electronic device 302 and a second electronic device 304. In one or more implementations, the device 100 is an example of the first electronic device 302 and/or the second electronic device 304. In at least one variation, however, the first electronic device 302 and/or the second electronic device 304 are configured differently from the device 100 without departing from the spirit or scope the described techniques.

The illustrated example 300 also includes first network 306 and second network 308. In accordance with the described techniques, the first network 306 has one or more characteristics which are different from the second network 308, which enable electronic devices to communicate (e.g., exchange messages) better over the first network 306 than over the second network 308. In at least one example, for instance, the first network 306 has higher bandwidth and/or lower latency than the second network 308. In this example, therefore, the second network 308 has lower bandwidth (e.g., constrained bandwidth) and/or higher latency than the first network 306. In at least one implementation, this is because the first network 306 and the second network 308 are different types of communication networks, examples of which are enumerated above. By way of example, in at least one implementation, the first network 306 is a non-terrestrial network (e.g., a wireless broadband network comprising one or more of cellular and/or Wi-Fi networking devices) and the second network 308 is a terrestrial network (e.g., a satellite network or constellation comprising at least one satellite). In at least one implementation, the second network 308 includes at least one relatively low-bandwidth and higher-latency communication channel.

While electronic devices are actively connected to the first network 306, communication (e.g., the exchange of messages and/or phone calls) may be referred to as “on-grid,” referring to the relative ubiquity and thus ability of those devices to easily connect at any given time to the network within locations covered by networking hardware of the first network 306. In contrast, a device that relies on the second network 308 to communicate may be referred to as being “off-grid,” because the ubiquitous, higher-bandwidth capabilities (e.g., available over the first network 306) are inaccessible to the device, limiting the ability of the device to communicate various payloads and/or limiting the ability of the device to communicate as quickly as over the first network 306.

In accordance with the described techniques, the first electronic device 302 and the second electronic device 304 communicate on-grid over the first network 306, including by exchanging one or more messages (e.g., instant messages) between each other. For instance, the first electronic device 302 sends messages (e.g., instant messages) to and receives messages from the second electronic device 304. Similarly, the second electronic device 304 sends messages to and receives messages from the first electronic device 302. The first electronic device 302 and the second electronic device 304 may also communicate in other ways over the first network 306, such as by voice calls, text (SMS) messages, e-mail, and/or other forms of electronic communication.

In accordance with the described techniques, while communicating (e.g., messaging) with each other on-grid over the first network 306, the first electronic device 302 and the second electronic device 304 exchange keys to use subsequently for secure off-grid communication, e.g., when at least one of the first electronic device 302 or the second electronic device 304 is off-grid communicating with the other device via the second network 308.

In the context of the illustrated example 300, for instance, the first electronic device 302 generates sender key 310 and communicates the sender key 310 to the second electronic device 304. Both devices store the sender key 310 in respective local storage—the first electronic device 302 stores the sender key 310 locally and the second electronic device 304 also stores the sender key 310 locally. In at least one example, the electronic devices store sender keys in a respective subscriber identity module (SIM) card, although the sender keys may be stored in other storage of those devices. The sender key 310 enables encryption and decryption of messages communicated between the first electronic device 302 and the second electronic device 304 when the first network 306 is inaccessible to the first electronic device 302, e.g., when the first electronic device 302 communicates from an off-grid location. With reference to the illustrated example 300, the sender key 310 enables encryption and decryption of the message 312 communicated from the first electronic device 302 to the second electronic device 304 over the second network 308.

In particular, the sender key 310 is used by the first electronic device 302 to generate a message key 314 that is unique to the message 312. The message key 314 is a lighter weight key (a “lightweight” key) relative to the sender key 310 and is usable when bandwidth is constrained, such as in connection with messaging over the second network 308. In one or more implementations, at least one aspect of the sender keys and/or their exchange is unsuitable for performing the exchange over the second network 308. For instance, sender keys may be too large to reliably send them over the second network 308.

When off-grid, the first electronic device 302 encrypts the message 312 with the message key 314 and communicates the encrypted message to the second electronic device 304 over the second network 308, e.g., using the RF circuitry 110. The second electronic device 304 receives the message 312 encrypted with the message key 314 and decrypts the message 312 using the sender key 310 previously stored locally by the second electronic device 304.

Oftentimes a user is associated with multiple electronic devices (e.g., a mobile phone, a smart watch, a tablet computer, a laptop computer, and so on), and those devices synchronize communications so that the user can have a ubiquitous messaging experience across the multiple devices. For instance, the user can receive and consume (e.g., view and/or listen to) a same message at both a mobile phone and a smart watch. Similarly, when the user sends a message from one device (e.g., the mobile phone) the user's devices synchronize to include that message at another device of the user (e.g., the user's smart watch). In this way, from the perspective of a user, message exchanges are consistent and up-to-date across the user's plurality of devices.

In the illustrated example 300, the second electronic device 304 is depicted as a mobile phone and depicted next to a smart watch. This represents the option that a user of the second electronic device 304 may be associated with multiple devices which synchronize communication between the devices. In at least one implementation, the described techniques enable the message 312 encrypted by the message key 314 and communicated from the first electronic device 302 to the second electronic device 304 to “fan out” to other devices associated with the second electronic device 304's user, e.g., to a smart watch and/or a tablet computer. In at least one implementation, for example, communicating the sender key 310 over the first network 306 to the second electronic device 304 causes the sender key 310 to be further communicated to at least one additional device associated with the user of the second electronic device 304. With the sender key 310, such additional devices can decrypt the message 312 encrypted with the message key 314.

In one or more implementations, the first electronic device 302 generates and communicates sender keys selectively to other electronic devices, e.g., to the second electronic device 304. For instance, the first electronic device 302 exchanges sender keys with other electronic devices that are associated with contacts of a user of the first electronic device 302 which satisfy one or more conditions. In at least one implementation, sender keys are exchanged only with high-priority contacts of a user of the first electronic device 302. By way of example, a user associated with the second electronic device 304 may be identified as a high-priority contact of the user of the first electronic device 302 due to being identified as at least of the following in relation to the user of the first electronic device 302: a family contact, a pinned contact (e.g., that is “pinned” to a prominent region of a messaging user interface of a messaging application), an emergency contact, a neighbor, and/or a contact included in a particular list of contacts such as an “approved list,” a list of friends, or a same interest group (e.g., a fan club, outdoor club), to name just a few.

Alternatively or additionally, the first electronic device 302 communicates the sender key 310 over the first network 306 to the second electronic device 304 based on frequent or recent communication of messages between the first electronic device 302 and the second electronic device 304. In one or more implementations, “frequent” communication refers to the communication of messages between devices satisfying a threshold frequency. The term “recent” communication may refer to the communication of messages between devices satisfying a threshold recency, e.g., within a threshold period of time from a current time. In at least one variation, the first electronic device 302 communicates the sender key 310 to electronic devices according to different bases, such as based on simply sending a message (e.g., an instant message) to or receiving a message from the second electronic device 304 over the first network 306, establishing a voice call with the second electronic device 304, and/or adding a contact corresponding to a user associated with the second electronic device 304 to a contact list, to name just a few.

In one or more implementations, the sender key 310 is communicated by the first electronic device 302 over the first network 306 to the second electronic device 304 in connection with an exchange of messages between the first electronic device 302 and the second electronic device 304. By way of example, the first electronic device 302 communicates the sender key 310 in the background in connection with a messaging session between the first electronic device 302 and the second electronic device 304, such as over a separate channel established over the first network 306 in connection with the messaging session.

For instance, during a messaging session over a communication channel that is established between the first electronic device 302 and the second electronic device 304 for exchanging messages (e.g., instant messages), an auxiliary channel may also be established to exchange other information that supports aspects of the messaging session and/or to support other communications between the first electronic device 302 and the second electronic device 304. In at least one implementation, the sender key 310 is communicated over such an auxiliary channel rather than over a channel used for exchanging the actual messages between the first electronic device 302 and the second electronic device 304. Alternatively, the sender key 310 is communicated over a same channel as the actual messages between the first electronic device 302 and the second electronic device 304. It is to be appreciated that sending the sender keys “in connection” with an exchange of messages may occur before the exchange (e.g., while establishing one or more communication channels to enable the message exchange), during the exchange of the messages, and/or after the exchange of the messages.

In one or more implementations, sender keys exchanged between the first electronic device 302 and the second electronic device 304 are unique to the exchange of messages between the first electronic device 302 and the second electronic device 304. The sender key 310 is not used and is not useable between the first electronic device 302 and any electronic device that is different from the second electronic device 304. In this way, a third electronic device is not provided information (e.g., the sender key 310) used to secure communications (e.g., messages) which are intended to be private between the first electronic device 302 and the second electronic device 304. This ensures that the sender keys exchanged between two electronic devices are usable only by those two electronic devices to encrypt and decrypt messages exchanged between those two electronic devices.

By way of example, sender keys exchanged between the first electronic device 302 and the second electronic device 304 are unique to an exchange of messages between those two electronic devices. In at least one implementation, this is because the sender keys are based on at least one characteristic of the exchange of messages between those two devices. Examples of the at least one characteristic include but are not limited to a number of messages exchanged (e.g., since a sender key 310 was last communicated between the devices), the content of one or more exchanged messages (e.g., the actual text, emojis, other content such as images or videos, expressions of sentiment such as likes and dislikes, etc.), one or more timestamps, a location of one or more of the electronic devices when a message is sent or received, and so on. In at least one implementation, the first electronic device 302 uses this at least one characteristic of the exchange of messages with the second electronic device 304 as input (e.g., key derivation material) to generate the sender key 310.

Alternatively or additionally, the first electronic device 302 uses other information (e.g., as input key derivation material) to generate the sender key 310. By way of example, this other information may include one or more random numbers (e.g., generated by a random number generator and/or a pseudo random number generator), identifiers of users associated with the first electronic device 302 and/or the second electronic device 304 (e.g., a phone number, e-mail address, and/or user handle), and so on.

In one or more implementations, the other information is a pseudonym (e.g., a pseudo random pseudonym) of at least one of a user associated with the first electronic device 302 or at user associated with the second electronic device 304. In at least one implementation, the first electronic device 302 generates such pseudonyms for one or more contacts satisfying one or more conditions, such as the example conditions discussed above. During an exchange of messages with the second electronic device 304, the first electronic device 302 may communicate the messages with those pseudonyms rather than using actual user identifiers, e.g., phone numbers or e-mail addresses. In this way, if a messaging session between the first electronic device 302 and the second electronic device 304 is compromised, since the messages do not include actual identifying information of the users of those devices, such information is not obtained by a malicious attacker. Instead, the malicious actor may be limited to obtaining the pseudonyms, which can be regenerated, e.g., pseudo-randomly. It is to be appreciated that the first electronic device 302 and/or the second electronic device 304 may input any of a variety of information as key derivation material to generate a sender key 310 that is cryptographically secure in accordance with the described techniques. In at least one example, the first electronic device 302 generates and manages sender keys in accordance with the following discussion.

In one or more implementations, a data encoding is generated that binds a key schedule (e.g., a ratchet) to a specific discussion, e.g., to the exchange of messages between the first electronic device 302 and the second electronic device 304 rather than to an exchange between any other combination of two electronic devices. As one example, the data encoding includes a first portion and a second portion. In at least one implementation, the first portion encodes an identifier (e.g., uniform resource locator comprising a phone number or e-mail address) of the electronic device sending the sender key (e.g., the first electronic device 302) on a number of bytes of the encoding and also includes additional encoded data. For instance, the identifier of the sender electronic device is encoded on four (4) bytes using the I2OSP function, and is followed by the additional encoded data, which comprises UTF-8 encoded data. In at least one implementation, the second portion of the data encoding encodes an identifier of the electronic device that receives the sender key (e.g., the second electronic device 304). For example, the identifier of the receiver electronic device is encoded on four (4) bytes using the I2OSP function and is followed by additional encoded data comprising UTF-8 encoded data. By encoding these two parts, the encoding achieves domain separation, which is important because the sender key 310 is randomly generated. This ensures that sender keys, and correspondingly encrypted messages, cannot be forwarded outside the intended conversation.

In one or more implementations, generating the sender key 310 includes initializing the sender key 310 with a randomly generated symmetric secret. Additionally or alternatively, the first electronic device 302 generates a sender key identifier from the initialized sender key (e.g., the randomly generated symmetric secret) using a key derivation function such as the HMAC key derivation function (HKDF) and by using a secure hash algorithm (SHA), such as SHA-256. In one or more implementations, the sender key identifier is further generated from at least one pseudo random key. In one or more implementations, such a sender key identifier can be derived only by electronic devices that receive the sender key at an initial index (index 0). If an electronic device is passed the sender key identifier at a subsequent index, the original sender key identifier cannot be derived. Due to this, in one or more implementations, the sender key identifier is also shared when distributing the sender key 310 between electronic devices, resulting in a simplified log.

After the first electronic device 302 generates the sender key 310, the first electronic device 302 communicates the generated sender key 310 to the second electronic device 304. As noted above, the first electronic device 302 and the second electronic device 304 store the sender key 310. For example, the first electronic device 302 and the second electronic device 304 each store the sender key 310 in local computer-readable storage media for subsequent use. In one or more implementations, the first electronic device 302 and the second electronic device 304 store the sender key 310 in association with an exchange of messages between those devices. For instance, each of the first electronic device 302 and the second electronic device 304 tracks (e.g., stores) the sender keys received from other devices and also tracks the particular message exchange (e.g., conversation) during which an individual sender key is received. When off-grid, therefore, a device can retrieve its own sender keys from storage for a respective message exchange.

As an additional security measure, the sender key 310 is rolled over based on one or more rollover thresholds. For example, the first electronic device 302 may generate and send a new sender key to the second electronic device 304 based on sending a threshold number of messages to the second electronic device 304 (e.g., one (1) message or a different number of messages), based on exchanging a threshold number of messages with the second electronic device 304 (e.g., one (1) message or a different number of messages), based on meeting or exceeding a threshold predefined time period (e.g., 15 minutes, 30 days, etc.), and so forth.

Additionally or alternatively, the first electronic device 302 may delete the sender key 310 from local storage based on a same or different rollover threshold from the rollover threshold for generating and sending a new sender key. In the scenario where the generate-and-send operation for a new sender key corresponds to a same rollover threshold as the threshold for purging an in-use sender key, the first electronic device 302 may simply write the new sender key over the in-use sender key in the storage. In at least one implementation, an electronic device that sends a sender key may have a different rollover threshold for the sender key than a different electronic device that receives the sender key. In at least one implementation, the one or more rollover thresholds are specified by a policy and/or protocol which governs on-grid and off-grid secure messaging in accordance with the described techniques. The policy and/or protocol can also govern key generation and key exchange as well as the preparation (e.g., encrypting) and sending of messages while off-grid to secure the exchange of those messages in accordance with the described techniques.

In accordance with the described techniques, the first electronic device 302 receives input to send the message 312 to the second electronic device 304 when the first network 306 is inaccessible by the first electronic device 302, such as when the first electronic device 302 is off grid. When the first electronic device 302 is off grid, for example, a user of the first electronic device 302 interacts with a messaging user interface provided by the first electronic device 302 to compose and then select to send the message 312 to the second electronic device 304. Responsive to such input, the first electronic device 302 encrypts the message 312 using the message key 314 and sends the message 312 encrypted using the message key 314 to the second electronic device 304 via the second network 308.

In one or more implementations, the first electronic device 302 generates the message key 314 by retrieving the sender key 310 from storage of the first electronic device 302. The first electronic device 302 retrieves the sender key 310 from storage based on the exchange of messages between the first electronic device 302 and the second electronic device 304. As noted above, for instance, the first electronic device 302 tracks which sender keys are sent and received in connection with which message exchanges, including which sender keys are sent and received in connection with the exchange of messages between the first electronic device 302 and the second electronic device 304. For instance, one or more identifiers of the message exchange between the first electronic device 302 and the second electronic device 304 may be associated with the sender key 310 in storage, such that those identifiers may be used by the first electronic device 302 to look up the sender key 310 in storage.

After the sender key 310 is retrieved from storage of the first electronic device 302, the first electronic device 302 derives the message key 314 based on the sender key 310 and optionally based on at least one characteristic of an exchange of messages between the first electronic device 302 and the second electronic device 304. In one or more implementations, the characteristic is particular to the exchange of messages between the first electronic device 302 and the second electronic device 304 since a sender key was last communicated between the first electronic device 302 and the second electronic device 304. In this way, when a new sender key is sent, the characteristic used is determined based on a new set of messages, e.g., the messages exchanged since the new sender key was sent. In one or more implementations, when a sender key 310 has not been sent between the first electronic device 302 and the second electronic device 304 during some preceding period of time (e.g., the last 30 days), the first electronic device 302 may cause off-grid communication, or off-grid communication with the described improved security, to be unavailable from the first electronic device 302. In at least one implementation, the first electronic device 302 may output a notification indicating this unavailability when this is the case. In at least one example, the first electronic device 302 generates and manages message keys in accordance with the following discussion.

Upon sending each new message, the sender of the sender key (e.g., the first electronic device 302) ratchets its sender key by deriving the message key 314 from the current sender key as well as the next chain key. The new sender key (with index i+1) is stored by the first electronic device 302 in storage instead of the previous sender key (with index i), and the message key 314 (with index i) is used to encrypt the new message. In one or more implementations, the message key 314 is not stored past the message being encrypted, e.g., the message key 314 is deleted once the respective message has been encrypted with the message key 314.

In one or more implementations, the ratchet index is stored in storage associated with the key derivation (e.g., in memory, a register, or SRAM), such as on a number of bits (e.g., 32 bits) of storage associated with the key derivation. In contrast, the ratchet index may be shortened to a smaller size (e.g., 16 bits) when transmitting over the air allowing for a large number of messages to be communicated per off-grid message exchange before returning on grid and rolling the sender key.

When receiving messages, the receiving electronic device (e.g., the second electronic device 304) ratchets up to the index of the message 312. In one or more implementations, the receiving electronic device stores any intermediary message keys with a smaller index if the respective messages were skipped and also stores a chain key of an incremented message index (index+1). After decrypting the message 312, the receiving device may discard the sender key. In one or more implementations, the receiving device may invoke a callback to discard the payload of the message 312 and/or to discard the message key 314. This discarding may enable the electronic devices to provide certified delivery guarantees, such as end-to-end reliability. Since sender keys are ratcheted using a key derivation function (KDF) ratchet, a compromised key state may allow a malicious attacker to derive future keys. Thus, in order to achieve post-compromise security, the electronic devices roll the keys regularly, such as responsive to the rollover thresholds as described above.

In one or more implementations, the first electronic device 302 and the second electronic device 304 use the message key 314 to encrypt and decrypt the message 312 in accordance with the following discussion. To encrypt the message 312, the first electronic device 302 derives a nonce (96 bit) and key (32 byte) to encrypt the message 312 with a cryptographic algorithm, such as Advance Encryption Standard-Galois/Counter Mode (AES-GCM). The first electronic device 302 derives the nonce and the key by invoking a key derivation function such as HKDF and by using the message key 314 as input key material and any relevant context strings. The output of the key derivation function (e.g., the encrypted message) is ciphertext, which the first electronic device 302 sends to the second electronic device 304 with the sender key identifier and the corresponding message index. Using this information and the stored sender key 310, the second electronic device 304 is able to decrypt and output the message 312.

Through the described on-grid exchange of sender keys which are usable by devices while subsequently off-grid to generate lightweight message keys for cryptographically securing and then communicating messages off-grid, the techniques described herein provide a variety of improvements. For instance, the described techniques provide forward secrecy for message exchanges involving at least one off-grid electronic device. The term “forward secrecy,” as used herein, refers to preventing an attacker from being able to decrypt past message traffic due to a compromise of a future message communication. This is achieved by updating key derivation material (e.g., ratcheting the sender key) as described above as well as by distributing the sender keys on a per-message basis, providing per-message forward secrecy.

The described techniques also provide post-compromise security for message exchanges involving at least one off-grid electronic device. The term “post-compromise security,” as used herein, refers to the ability of the system to recover from a compromised state, such that an attacker is prevented from decrypting future traffic between electronic devices after a compromise occurs. The described techniques recover from a compromised state by rolling the sender keys, such that sending a new sender key over a secure channel can result in recovery from a compromised state. Additionally, due to the described ratcheting, new key derivation material is generated to derive a next message key for encrypting messages on a per message basis. Due to this, forward secrecy is recovered in most cases when a message recipient comes back online.

In addition to these benefits, the described techniques also provide security against some attacks from quantum computers (e.g., passive quantum attackers) due to the use of 256-bit symmetric cryptography (e.g., SHA-256) when generating sender key identifiers.

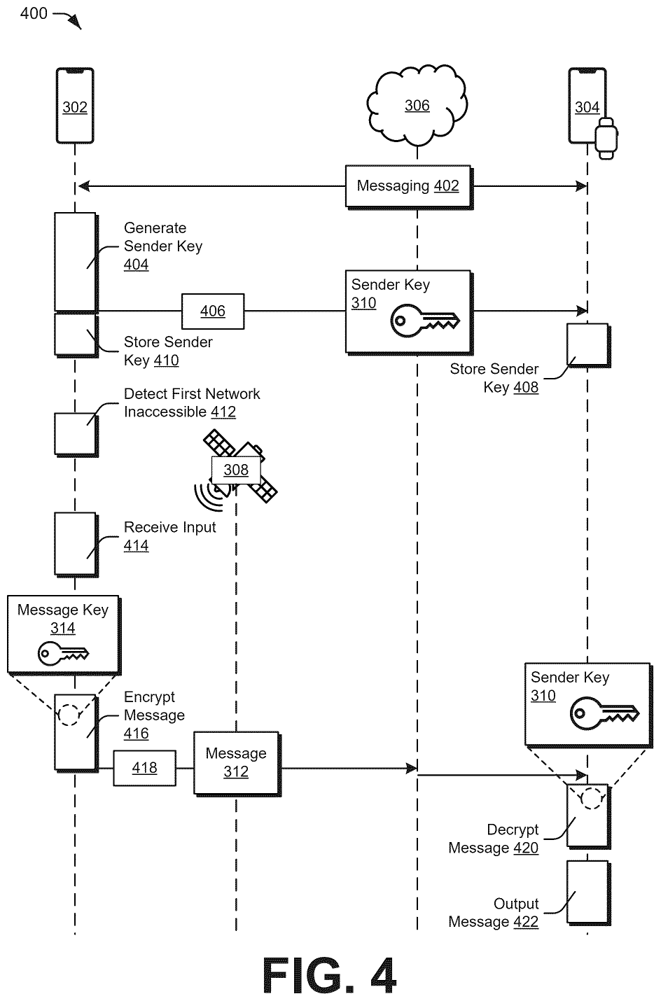

In the context of one example of exchanging sender keys on-grid and using the sender key 310 to encrypt the message key 314 for secure communication when the first electronic device 302 is off-grid, consider the following discussion of FIG. 4.

FIG. 4 depicts a non-limiting example 400 in which sender keys are exchanged between devices on-grid to enable secure communication when subsequently off-grid by encrypting messages using lighter weight message keys based on the sender keys. The example 400 includes from FIG. 3 the first electronic device 302, the second electronic device 304, the first network 306, and the second network 308.

The example 300 also includes a variety of example communications and operations between the first electronic device 302, the second electronic device 304, the first network 306, and the second network 308 over time. In this example 300, the communications and operations are positioned vertically based on time, such that communications and operations closer to a top of the example occur prior to communications or operations further from the top of the example. It follows also that communications or operations closer to a bottom of the example occur subsequent to communications or operations further from the bottom.

The illustrated example 400 depicts the first electronic device 302 and the second electronic device 304 messaging 402 over the first network 306. Although the example 400 depicts the second network 308, the messaging 402 does not involve the second network 308 (e.g., a terrestrial network). Instead, the first electronic device 302 and the second electronic device 304 are able to carry out the messaging 402 using only non-terrestrial networks, e.g., the first network 306.

At 404, the first electronic device 302 generates the sender key 310, such as in accordance with the techniques described above. It is to be appreciated, however, that the first electronic device 302 may generate the sender key 310 using other cryptographic techniques without departing from the spirit or scope of the described techniques, such as by using other key derivation functions, different hashing functions, and so on.

At 406, the first electronic device 302 sends the sender key 310 over the first network 306 to the second electronic device 304. As mentioned above, the first electronic device 302 may send the sender key 310 in connection with an exchange of messages with the second electronic device 304, such as in connection with at least a portion of the messaging 402. In one or more implementations, the first electronic device 302 sends the sender key 310 at 402 in the background in connection with the messaging 402. At 408, the second electronic device 304 stores the sender key 310 in local storage. The first electronic device 302 also stores the sender key 310 in local storage at 410.

As noted above, the first electronic device 302 uses the lighter weight security based on the sender key 310 when off grid, e.g., when the first network 306 is inaccessible by the first electronic device 302. This is because the bandwidth of the second network 308 is constrained relative to the first network 306. At 412, the first electronic device 302 detects that the first network 306 is inaccessible. While the first network 306 is inaccessible by the first electronic device 302 (e.g., because the first electronic device 302 is in an off-grid location), the first electronic device 302 receives input 414 to communicate a message to the second electronic device 304. For instance, the first electronic device 302 receives input 414 via a messaging user interface (e.g., of a messaging application) to compose and send the message 312 to the second electronic device 304.

Responsive to receiving the input 414, at 416 the first electronic device 302 encrypts the message 312 with the message key 314, which is derived based on the sender key 310. The first electronic device 302 may generate the message key 314 based on the sender key 310 and encrypt the message 312 in accordance with the techniques described above and below. Alternatively, the first electronic device 302 may generate the message key 314 based on the sender key 310 and encrypt 416 the message 312 using different techniques.

At 418, the first electronic device 302 sends the message 312 encrypted with the message key 314 directly to the second network 308, e.g., to a satellite of the second network 308. The second network 308 forwards the encrypted message 312 to the first network 306 which delivers the message 312 to the second electronic device 304. At 420, the second electronic device 304 decrypts the encrypted message 312 based on the sender key 310. At 422, the second electronic device 304 outputs the decrypted message 312, such as by presenting the decrypted message via a messaging user interface displayed by the second electronic device 304 and/or by outputting the message audibly via one or more speakers of the second electronic device 304.

In at least one variation, the system for implementing the described techniques may include one or more different components than illustrated in the preceding FIGS. 3 and 4. In at least one example, the components depicted in those preceding figures correspond to a scenario where the first electronic device 302 and the second electronic device 304 are implemented on a same platform, have a same operating system or both have operating systems that support those techniques, and/or are otherwise capable of using a same messaging protocol and/or messaging application. In different implementations, though, the first electronic device 302 and the second electronic device 304 may be implemented on different platforms, have different operating systems that do not both support the above-described techniques, and/or are otherwise not configured to use the above-described protocol. In such implementations, the operative environment and techniques may vary from those discussed above.

By way of example and not limitation, a system that supports on-grid and off-grid secure communication between electronic devices may further include an interworking function (IWF), which can be used to bridge gaps between networks that use different technologies or telecom protocols or have different operating systems, and convert one interface to another, such as to convert messages from one messaging platform or protocol to another messaging platform or protocol. In implementations involving an IWF, the IWF may be the on-grid recipient of a sender key 314 rather than a receiving electronic device, e.g., the other endpoint of an exchange of messages.

Due to such involvement, the IWF is also involved in the creation of keys exchanged between the first electronic device 302 and the IWF. In one or more implementations, the IWF includes or otherwise has access to key derivation material with corresponding storage, key rolling, and expiration policies. For example, the key derivation material associated with the IWF includes certification authority keys and a certificate chain. In one or more implementations, these keys are implemented, at least in part, using the NIST P-256 elliptic curve key exchange. This ensures that the keys have certification authority and certifies that the keying material in the root certification and in the path down to signing a certificate satisfy acceptable security. Additionally or alternatively, the key derivation material associated with the IWF may include intermediary signing key(s) implemented using the NIST P-256 elliptic curve digital signature algorithm (ECDSA). In one or more implementations, the intermediary signing key(s) are configured to rotate after an interval of time (e.g., 1 year) and also have an expiration time period (e.g., 3 years). Additionally or alternatively, the key derivation material associated with the IWF includes NIST P-256 ephemeral keys for encryption, such as a pair of keys per country.

To enable the first electronic device 302 to send the message 312 while off gid to an electronic device on a different messaging platform or having a different operating system, the described techniques may anonymously bootstrap key derivation material. As part of this, while on grid, the first electronic device 302 and the IWF initiate a key exchange for the creation of the sender key 310. Rather than completing the key exchange while both electronic devices are on grid, in the scenario involving different platforms or operating systems, the IWF waits to complete the key exchange until the first electronic device 302 both is off grid and initiates an exchange of messages. This ensures that the IWF does not learn when the first electronic device 302 is off grid until the exchange of messages is initiated by the first electronic device 302.

In this scenario, the first electronic device 302 encrypts its public key with a symmetric key, so it cannot be released until the first electronic device 302 goes off grid. This prevents release of a shared secret to any intermediaries (e.g., servers, service providers, networking equipment, networking providers, etc.) that form part of and/or that are along the communication path represented by the first network 306, until the first electronic device 302 is off grid and is using the key. Further, this prevents at least some of those intermediaries from determining all the possible mobile station international subscriber directory numbers (MSISDN) that might go offline. In one or more implementations, the first electronic device 302 stores the symmetric key privately in storage until establishing an off-grid link subsequently, e.g., with the second network 308. This prevents the first electronic device 302 and the IWF from colluding to perform a key-exchange for on-grid participants, and then performing a brute force attack over all MSISDN to find matching MSISDN tags. Rather, the first electronic device 302 and the IWF may initiate another key exchange: a first scenario where the key exchange expires based on an expiration threshold; or a second scenario when the first electronic device 302 has gone off grid, exchanged messages using the keys exchanged with the IWF, and has come back on grid.

When the first electronic device 302 is off grid and sends the message 312 to an electronic device on a different messaging platform, has a different operating system, or uses a different telecom protocol, the described techniques use the keys exchanged with the IWF. Consider a scenario where the first electronic device 302 receives input to communicate the message 312 to an electronic device on a different messaging platform, that has a different operating system which does not support the same protocol, or that simply uses a different telecom protocol.

In this scenario, the first electronic device 302 is operable to create a satellite uplink as part of communicating the message 312. In one or more implementations, the first electronic device 302 completes the key handshake that was started with the IWF while on grid. The first electronic device 302 also causes a ratcheting state to be set up at the IWF for communication with the first electronic device 302. The first electronic device 302 does this by sending the stored symmetric key that was used to encrypt a public key of the first electronic device 302, which allows the public key to be decrypted and forward to the IWF, which can then complete the key handshake. Release of the symmetric key enables secure communication, which then allows the IWF to partake in a protocol that validates ownership of a SIM (subscriber identity module) associated with the first electronic device 302, such as through an EKE-AKA (encrypted key exchange—authenticated key exchange) protocol.

As discussed above and below, in one or more implementations, sender keys are exchanged selectively with other electronic devices, such as electronic devices that are associated with contacts of a user that satisfy one or more criteria. For example, the exchange of sender keys that enable subsequent off grid communication is limited to contacts on predefined lists, examples of which are discussed above, and include, for instance, emergency contacts, pinned contacts, and contacts on an “approved” list, to name a few. Additionally, or alternatively, the techniques described herein limit the messages that are communicated to the first electronic device 302 while off grid to messages from those contacts. Messages from other contacts, which do not satisfy such conditions are held back, such as until the first electronic device 302 returns to an on-grid location. In at least one implementation, the techniques also allow messages to be communicated to the first electronic device 302 that are from contacts or devices to which the first electronic device 302 has sent a message while off grid. Thus, messages from the contacts and/or electronic devices that satisfy the one or more conditions are forwarded to the first electronic device 302 while it is off grid, but messages from other contacts and/or devices are not forwarded. As a result, while the first electronic device 302 is off grid, the described techniques allow the first electronic device 302 to exchange messages with the electronic devices (e.g., the second electronic device 304) of contacts which satisfy one or more criteria, e.g., emergency contacts or contacts that the first electronic device 302 has messaged while off grid.

As noted above, in one or more implementations, a system that supports the described techniques includes an interworking function (IWF), which can be used to bridge gaps between networks that use different technologies or telecom protocols or have different operating systems, and convert one interface to another, such as to convert messages from one messaging platform or protocol to another messaging platform or protocol. The IWF includes both the hardware and software components to convert between different communications technologies, such as between non-terrestrial networks (e.g., the first network 306) and terrestrial networks (e.g., the second network 308) and/or between a first communication technology associated with a first service provider and a second communication technology (e.g., SMS) associated with at least a second service provider. By way of example, the IWF is a secure nexus for communication between the first network 306 and the second network 308. In at least one implementation, for instance, the first network 306 includes the IWF. Broadly, the IWF is configured to decrypt messages (e.g., messages sent from other electronic devices to the first electronic device 302 while the first electronic device 302 is off grid) and keep those messages secret from the second network 308. Despite keeping the messages secret from the second network 308, the IWF may nevertheless forward those messages to appropriate recipients (e.g., contacts) via the first network 306. Because the IWF can function in this way, the described techniques are further adapted to maintain the privacy of high-priority contacts (e.g., emergency contacts) associated with a user of the first electronic device.

In operation, the IWF can learn all the contacts to which the first electronic device 302 sends messages over the first network 306. Where all outgoing messages from the first electronic device 302 to recipient electronic devices are sent and where all incoming messages are relayed to the second network 308, nothing is revealed to the IWF. However, due to bandwidth constraints of off-grid communication, the described techniques prevent at least some messages from being forwarded via the second network 308 to the first electronic device 302 while it is off grid. These messages are stored for on-grid delivery later, when the first electronic device 302 is determined to have returned on grid. In at least one implementation, the messages that are held from being forwarded while the first electronic device 302 is off grid are neither responses to outgoing messages sent from the first electronic device 302 while off grid nor messages from high-profile contacts. In other words, messages that respond to outgoing messages sent from the first electronic device 302 while off grid are released and forwarded via the second network 308 to the first electronic device 302 while it is off grid. Additionally, messages from high-profile contacts are forwarded via the second network 308 while the first electronic device 302 is off grid. In one or more implementations, the IWF controls the holding and forwarding of such messages.

Notably, a variety of security aspects are improved by preventing entities and/or communication equipment across the second network 308 from learning the contacts which correspond to the messages being released and forwarded to the first electronic device 302 while it is off grid. Exposure of such contact information at various points along the second network 308 can provide opportunities for malicious attacks, such as by obtaining contact information and then imitating an “important” contact of the user. As a safeguard, in one or more implementations, the described techniques do not use easily identifiable information of the contacts which can reveal those contacts to an attacker, or even to an entity or hardware (e.g., servers or networking hardware) of an entity legitimately involved in the exchange of messages, such as an IWF or other service provider (e.g., a company that provides the electronic devices). Instead, pseudonyms are generated in place of easily identifiable identifiers for select contacts using one or more pseudonym generation techniques and/or one or more other anonymizing techniques.

These pseudonyms may be added to an “approved” list which permits the selective transmission of messages to the first electronic device 302 while it is off grid. Use of the pseudonyms as identifiers and use of the “approved” list enable the exchange of messages between select contacts and the first electronic device 302 while the first electronic device 302 is off grid. In particular, the approved list enables such message exchange without revealing the selected contacts, even to legitimate entities and/or to the servers via which the messages are passed during message exchange, including during off-grid message exchange.

In at least one implementation, the “approved” list of pseudonyms is passed to the second network 308. Because outgoing messages from the first electronic device 302 while it is off grid include a respective pseudonym and/or have it attached, the second network 308 can update the “approved” list in connection with the communication of such outgoing messages. When such a message is then received on the first network 306, the pseudonyms can be computed for those incoming messages and attached to the encrypted messages. This allows the second network 308 to cross-reference an incoming pseudonym with the approved list.

In at least one implementation, a pseudonym generation technique computes the pseudonyms using a symmetric key derived for the purpose of generating the pseudonyms. Other anonymizing techniques may be used to obscure identifiers of the contacts with which the first electronic device 302 exchanges messages while off grid so that the anonymized identifiers cannot be used to identify those contacts, either by legitimate intermediaries (e.g., servers) or malicious attackers.

In at least one example, messages sent from an electronic device (e.g., the second electronic device 304) of such a contact to the first electronic device 302 while off grid include or utilize a pseudonym or otherwise anonymized identifier of the contact in place of easily identifiable contact information. The pseudonym or anonymized identifier is known to the first electronic device 302 so that the messages received can be appropriately identified to a user of the first electronic device 302, such as in a messaging user interface. As mentioned above, however, the pseudonym or anonymized identifier is not able to be tied to a specific contact by any of the intermediaries (e.g., servers) involved in the messaging exchange, which prevents them and attackers from learning who are the “important” contacts of a user of the first electronic device 302. In addition, messages sent from the first electronic device 302 while it is off grid to an electronic device of one of the select contacts also include or otherwise utilize the pseudonym or anonymized identifier generated for the contact.

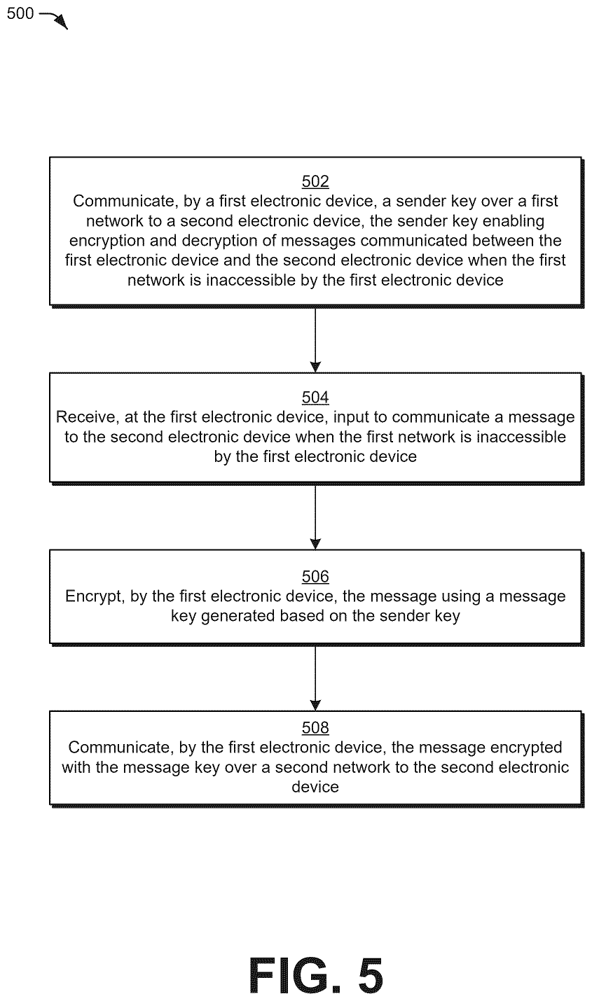

FIG. 5 depicts a procedure of a method 500 for on-grid and off-grid secure messaging.

In some embodiments, method 500 (FIG. 5) is performed at a first computer system (as described herein) via a system process (e.g., an operating system process, a server system process) that is different from one or more applications executing and/or installed on the first computer system.

In some embodiments, method 500 (FIG. 5) is performed at a first computer system (as described herein) by an application that is different from a system process. In some embodiments, the instructions of the application, when executed, control the first computer system to perform method 500 (FIG. 5) by calling an application programming interface (API) provided by the system process. In some embodiments, the application performs at least a portion of method 500 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 500 (FIG. 5) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the first computer system to perform method 500 (FIG. 5) by calling an application programming interface (API) provided by the system process using one or more parameters.

In some embodiments, exemplary APIs provided by the system process include one or more of: an off-grid secure messaging API, a pairing API (e.g., for establishing secure connection, e.g., with an accessory), a device detection API (e.g., for locating nearby devices, e.g., media devices and/or smartphone), a location detection API, a locator API, a maps API, a sensor API, a messaging API, a push notification API, a streaming API, a web browser API (e.g., WebKit API), a networking API, a Wi-Fi API, a Bluetooth API, an NFC API, a UWB API, a contact transfer API, photos API, camera API, and/or image processing API.

In some embodiments, the API 220 defines a first API call that can be provided by API calling instructions 216, wherein the definition for the first API call specifies the following call parameters: a message payload (e.g., text of a message to be sent to a receiving electronic device) and an identifier of the receiving electronic device (e.g., e-mail and/or phone number). The identifier of the receiving electronic device may enable the API 220 to look up a sender key 310 stored in storage for a conversation between the first electronic device 302 (sending electronic device) and the second electronic device 304 (receiving electronic device).

In some embodiments, the API 220 defines a first API call response that can be provided to the application by API calling instructions 216, wherein the first API call response may provide to the application status information that relates to whether the API 220 was able to encrypt the message 312 and/or send the message 312 as encrypted (in the case of the first electronic device 302) and the decrypted message for output in the case of the second electronic device 304).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 210) that runs the application. In some embodiments, the set of implementation instructions is included in an electronic device that is separate from the device that runs the application.

In one or more implementations, on-grid and off-grid secure communication is implemented in accordance with the following procedure.

A sender key is communicated by a first electronic device over a first network to a second electronic device (block 502). In accordance with the principles discussed herein, the sender key enables encryption and decryption of messages communicated between the first electronic device and the second electronic device when the first network is inaccessible by the first electronic device. By way of example, the first electronic device 302 communicates the sender key 310 over the first network 306 to the second electronic device 304 when the first electronic device 302 and the second electronic device 304 are on grid. As discussed above, the sender key 310 enables encryption and decryption of messages (e.g., the message 312) communicated between the first electronic device 302 and the second electronic device 304 when the first network 306 is inaccessible by the first electronic device 302. In at least one implementation, communication of the sender key 310 over the first network 306 to the second electronic device 304 causes the sender key 310 to be further communicated to at least one additional device associated with the user of the second electronic device 304. In other words, the sender key 310 is fanned out to additional devices associated with a user of the second electronic device 304. With the sender key 310, such additional devices can decrypt the message 312 encrypted with the message key 314.

Although not depicted in the method 500, in one or more implementations, the method 500 further includes a step of generating the sender key, which can occur before the communication at block 502 of the sender key over the first network. In at least one implementation, the sender key 310 is generated by an electronic device, such as by a first electronic device 302 prior to communication to a second electronic device 304 over the first network 306. Because generating, communicating, and maintaining sender keys which satisfy a threshold level of security for implementing the described techniques can consume significant computing resources-such as processing cycles and memory for generating those sender keys, network bandwidth for communicating the sender keys, and available space on computer-readable media for storing the sender keys—in one or more implementations, the described techniques selectively limit which other electronic devices the first electronic device 302 generates the sender keys for and communicates those keys to, such as for other electronic devices that are associated with high-priority contacts of a user of the first electronic device and/or that satisfy one or more other criteria as discussed above.

In one or more implementations, the sender key 310 is generated using one or more encryption key generation algorithms. By way of example and not limitation, those one or more encryption key generation algorithms includes a set of algorithms, such as a key-encapsulation mechanism (KEM), that can be used under certain conditions by two parties (e.g., the first electronic device 302 and the second electronic device 304) to establish a shared secret key (e.g., the sender key 310) over a public channel (e.g., the first network 306). In at least one implementation, for instance, the sender key 310 is generated using a post-quantum encryption key generation technique, such as module-lattice-based key encapsulation mechanism (ML-KEM). By encrypting the sender key 310 using such encryption, the described techniques harden the sender key 310 to resist attacks from quantum computers. Alternatively, or in addition, the sender key 310 is generated using an elliptic curve cryptography technique. That way, in implementations where both a post-quantum encryption key generation technique (e.g., ML-KEM) and elliptic curve cryptography (a “classic” cryptography technique) are used for key generation, an attacker must defeat both cryptography types to compromise the security of the sender key 310.

While generating a sender key 310 in this way provides robust security for enabling secure off-grid communications in accordance with the techniques discussed above and below, such techniques can also result in a sender key 310 that is relatively large and unsuitable (e.g., too large) to be exchanged between electronic devices when one or both of them are off grid. Accordingly, the sender key 310 can only be communicated or otherwise exchange between the device when on-grid, communicating over a wireless (Wi-Fi) and/or cellular network, such as the first network 306. In the context of FIG. 3, for instance, the sender key 310 may be too large due to the size of its robust cryptography to be communicated from the first electronic device 302 to the second electronic device 304 (or vice versa) across the second network 308. Indeed, any attempts to communicate such keys over the second network 308 may time out and/or communications may risk becoming corrupted due to a size of the sender key 310. By encrypting the sender key 310 with a post-quantum encryption technique, however, the described techniques ensure robust security against potential future attacks from quantum computers for communications between devices when at least one of those devices is off grid. These techniques also provide enhanced long-term security for the sender key 310, safeguarding sensitive communications between devices when communicating off grid, even in the event of advancements in quantum computing capabilities and their use in attacking off-grid communications.

Although not depicted in the method 500, in one or more implementations, the method 500 further includes a step of generating a pseudonym or anonymized identifier for a contact (e.g., a user) associated with the second electronic device 304. Such a pseudonym or anonymized identifier prevents legitimate entities, such as the servers via which the messages are communicated during off-grid message exchange, and malicious attackers from learning an identity of the contact.

Input to communicate a message to the second electronic device is received at the first electronic device when the first network is inaccessible by the first electronic device (block 504). By way of example, the first electronic device 302 receives input 412 to communicate the message 312 to the second electronic device 304 when the first network 306 is inaccessible by the first electronic device 302.

The message is encrypted by the first electronic device using a message key generated based on the sender key (block 506). By way of example, the first electronic device 302 encrypts 416 the message 312 using the message key 314, which is generated based on the sender key 310.

The message, encrypted with the message key, is communicated by the first electronic device over a second network to the second electronic device (block 508). By way of example, the first electronic device 302 communicates the message 312, which is encrypted using the message key 314 at block 506, over the second network 308 (e.g., by connecting directly to at least one satellite) to the second electronic device 304. In one or more implementations, the message 312 includes or is otherwise communicated utilizing the pseudonym or anonymized identifier generated for the contact of the second electronic device 304, which enables message exchange without revealing the contact to any intermediate entities (e.g., servers) along the path of communication between the first electronic device 302 and the second electronic device 304. It is to be appreciated that such pseudonyms and anonymized identifiers can be used in both directions of message exchange while at least one of the first electronic device 302 or the second electronic device 304 is at an off-grid location during message exchange. As noted above, in one or more implementations, an IWF is a nexus of communication along the path across the first network 306 and the second network 308. In at least one such implementation, the IWF implements the pseudonym, such that the IWF determines who the intended recipient (e.g., contact) is of the message 312 and forwards the message 312 to the second electronic device 304. Advantageously, use of pseudonyms and/or anonymized identifiers prevents the intermediate entities (e.g., servers) and malicious parties from learning the identities of message senders and recipients while securely exchanging messages off grid.

As described above, one aspect of the present technology is the gathering and use of data available from various sources to improve communication between devices. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a user interacts with a device. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method, comprising:
communicating, by a first electronic device, a sender key over a first network to a second electronic device, the sender key enabling encryption and decryption of messages communicated between the first electronic device and the second electronic device when the first network is inaccessible by the first electronic device; and
responsive to input, at the first electronic device, to communicate a message to the second electronic device when the first network is inaccessible by the first electronic device:
encrypting, by the first electronic device, the message using a message key generated based on the sender key; and
communicating, by the first electronic device, the message encrypted with the message key over a second network to the second electronic device.

2. The computer-implemented method of claim 1, wherein the first network comprises a wireless broadband network and the second network comprises a satellite network.

3. The computer-implemented method of claim 1, further comprising generating the sender key using one or more encryption key generation algorithms.

4. The computer-implemented method of claim 3, wherein the one or more encryption key generation algorithms comprise a post-quantum encryption key generation technique.

5. The computer-implemented method of claim 4, wherein the post-quantum encryption key generation technique is module-lattice-based key encapsulation mechanism (ML-KEM).

6. The computer-implemented method of claim 5, wherein the one or more encryption key generation algorithms further comprise an elliptic curve cryptography technique.

7. The computer-implemented method of claim 1, wherein the sender key is selectively communicated over the first network to the second electronic device based on at least one of frequent or recent communication of messages between the first electronic device and the second electronic device.

8. The computer-implemented method of claim 1, wherein the sender key is selectively communicated over the first network to the second electronic device based on the second electronic device being associated with a high-priority contact of a user associated with the first electronic device.

9. The computer-implemented method of claim 1, wherein the sender key is communicated in connection with an exchange of messages between the first electronic device and the second electronic device.

10. The computer-implemented method of claim 1, further comprising:
generating a pseudonym for a contact associated with the second electronic device, wherein the sender key is selectively communicated over the first network to the second electronic device based on the contact satisfying one or more criteria; and
communicating the message over the second network to the second electronic device utilizing the pseudonym without revealing an identity of the contact to any intermediary along a path of communication to the second electronic device.

11. The computer-implemented method of claim 1, wherein the sender key is stored by the first electronic device and the second electronic device for one or more predefined time periods and is stored in association with an exchange of messages between the first electronic device and the second electronic device.

12. The computer-implemented method of claim 11, further comprising generating, by the first electronic device, the message key by:
retrieving the sender key from storage of the first electronic device based on the exchange of messages between the first electronic device and the second electronic device; and
deriving the message key based on the sender key and at least one characteristic of the exchange of messages since the sender key was communicated to the second electronic device.

13. The computer-implemented method of claim 11, wherein the message encrypted with the message key is decryptable by the second electronic device using the sender key stored by the second electronic device.

14. The computer-implemented method of claim 1, further comprising generating, by the first electronic device, the sender key based on a first identifier associated with the first electronic device and a second identifier associated with the second electronic device.

15. The computer-implemented method of claim 1, wherein the sender key is generated uniquely based on an exchange of messages between the first electronic device and the second electronic device.

16. The computer-implemented method of claim 1, further comprising responsive to a rollover threshold, communicating, by the first electronic device, a new sender key over the first network to the second electronic device.

17. The computer-implemented method of claim 1, wherein the communicating the sender key over the first network to the second electronic device causes the sender key to be further communicated to at least one additional electronic device associated with a user that is associated with the second electronic device.

18. A non-transitory computer-readable storage medium storing one or more programs, the one or more programs comprising instructions that, when executed by an electronic device, cause the electronic device to perform operations including:
communicating a sender key over a first network to an additional electronic device, the sender key enabling encryption and decryption of messages communicated between the electronic device and the additional electronic device when the first network is inaccessible by the electronic device; and
responsive to input, at the electronic device, to communicate a message to the additional electronic device when the first network is inaccessible by the electronic device:
encrypting, by the electronic device, the message using a message key generated based on the sender key; and
communicating, by the electronic device, the message encrypted with the message key over a second network to the additional electronic device.

19. An electronic device comprising:
one or more processors;
memory; and
one or more programs, wherein the one or more programs are stored in the memory and configured to be executed by the one or more processors, the one or more programs including instructions for:
communicating a sender key over a first network to an additional electronic device, the sender key enabling encryption and decryption of messages communicated between the electronic device and the additional electronic device when the first network is inaccessible by the electronic device; and
responsive to input, at the electronic device, to communicate a message to the additional electronic device when the first network is inaccessible by the electronic device:
encrypting, by the electronic device, the message using a message key generated based on the sender key; and
communicating, by the electronic device, the message encrypted with the message key over a second network to the additional electronic device.

20. The electronic device of claim 19, wherein the second network comprises a satellite network.
